(19) United States
(12) Patent Application Publication
(10) Pub. No.: US 2009/0266095 A1
(43) Pub. Date: Oct. 29, 2009

(54) Refrigerated Preservation Unit, Particularly for Domestic Use

(76) Inventor: Marco Pruneri, Bolzano (IT)

Correspondence Address: COLEMAN SUDOL SAPONE, P.C., 714 COLORADO AVENUE, BRIDGE PORT, CT, 06605-1601, US

(21) Appl. No.: 11/992,204

(22) PCT Filed: Sep. 25, 2006
(86) PCT No.: PCT/EP2006/009286

§ 371 Date: Mar. 18, 2008

(30) Foreign Application Priority Data
Sep. 27, 2005 (IT) MI2005A001789

(51) Int. Cl. F25D 23/00; F25D 17/06; F25D 23/02; F25B 1/00; F16L 9/14; F04B 53/00

(52) U.S. Cl. 62/231; 62/259.1; 62/426; 62/449; 62/498; 138/149; 417/312

(57) ABSTRACT

A refrigerated preservation unit, particularly for domestic use, includes an internal compartment provided with an access door and with a refrigeration means. The unit includes an atmosphere control device constituted by a nitrogen generator, a control PLC, an oxygen analyzer, an overpressure/negative pressure valve, and a flexible plenum chamber. These components are all installed in a lower region of the unit, in the compartment normally used to accommodate the compressor and the condenser in traditional domestic refrigerators. The present invention allows to considerably improve the preservation times of food products stored inside home refrigerators when they are preserved loose and/or when the packages that contain them are not hermetically closed. The present invention allows in some cases to even treble the preservation time of the preserved products with a minimal additional energy expenditure of the electrical appliance.

The present invention relates to a refrigerated preservation unit particularly for domestic use.

It is known that food products preserved within home refrigerators deteriorate over different times, according to each type of product.

The beneficial effect of a controlled and modified atmosphere in the preservation of food products is also known.

In particular, currently a vast majority of refrigerated storage units for preserving agroalimentary products is provided not only with the usual refrigeration system but also with systems for controlling the atmosphere within the goods preservation cells.

In particular, these systems monitor and control the percentages of oxygen and carbon dioxide within the storage spaces. This type of system allows, in most cases, to double the preservation times of the preserved agroalimentary products, and in some cases, with latest-generation monitoring and control systems (ULO, acronym of Ultra Low Oxygen), the preservation times are trebled with respect to a preservation system composed solely of a refrigeration system.

Also in the field of packaging, a modified atmosphere allows to significantly increase the preservation times of most preserved products.

That explains the increasing proliferation of modified-atmosphere packagings.

In the case of packaging, one speaks of modified atmosphere instead of controlled atmosphere, since the atmosphere introduced in the package is “static” and is not modified further once the package has been sealed.

However, in both cases, one speaks of an atmosphere which is modified, in its oxygen and carbon dioxide values, with respect to the atmosphere that we usually breathe.

The aim of the present invention is to provide an improved domestic refrigeration system.

An object of the invention is to provide a refrigeration system which can considerably improve the preservation times of food products preserved within home refrigerators when they are preserved loose and/or the packages that contain them are not hermetically closed.

A further object of the invention is to provide a domestic refrigeration system which allows to significantly extend the preservation time of the preserved products with a minimal additional energy expenditure of the electrical appliance.

A further object is to provide a refrigeration system of the domestic type which offers all the assurances of safety and reliability that are required for the specific use.

This aim and these and other objects, which will become better apparent hereinafter, are achieved by a refrigerated preservation unit, particularly for domestic use, comprising at least one internal compartment provided with an access door and with a refrigerating means for refrigerating said compartment, characterized in that it comprises a device for controlling the atmosphere of the at least one internal compartment.

Further characteristics and advantages will become better apparent from the following detailed description of preferred but not exclusive embodiments of the invention, illustrated by way of non-limiting example in the accompanying drawings, wherein:

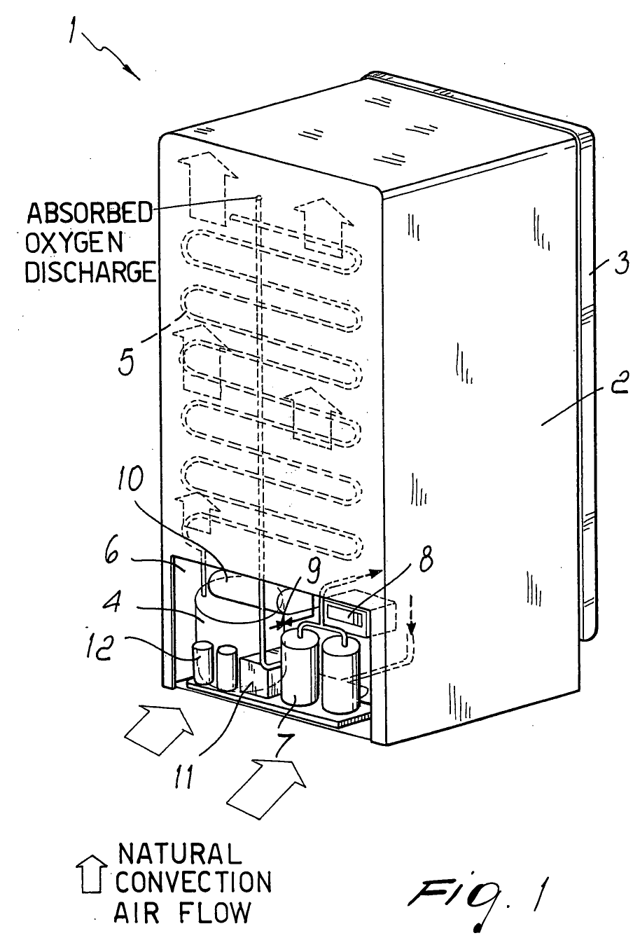

FIG. 1 is a rear perspective view of a refrigeration preservation unit of the domestic type, schematically illustrating the arrangement of the components of the unit according to the present invention;

FIG. 2 is a rear perspective view of a refrigeration unit of the domestic type, schematically illustrating the arrangement of the components of the unit according to a further aspect of the present invention;

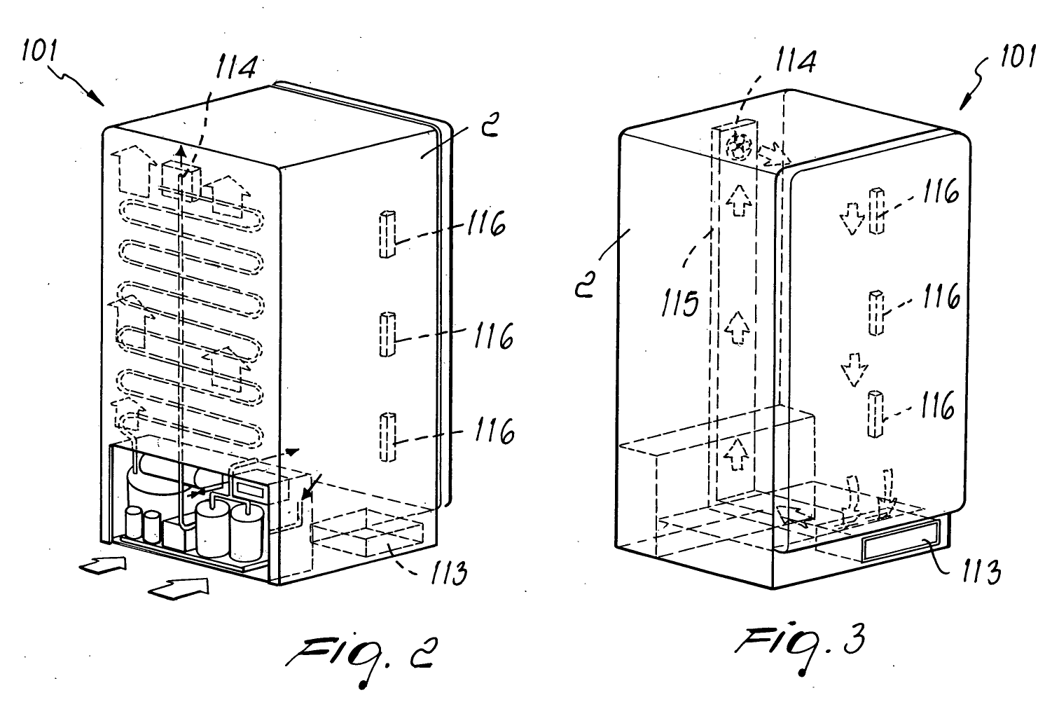

FIG. 3 is a front perspective view of the refrigeration unit of FIG. 2.

With reference to the cited figures, a refrigeration unit according to the invention, generally designated by the reference numeral 1, comprises a box-like structure 2, which is provided with an internal compartment, with an access door 3, and with a refrigeration means constituted, in a per se known manner, by a compressor and condenser 4, inserted in a compartment 6, and by a coil 5.

According to the present invention, the refrigeration unit also has a device for controlling the atmosphere of the internal compartment.

The atmosphere control device comprises a nitrogen generator 7, a control PLC associated with an oxygen analyzer, generally designated by the reference numeral 8, an overpressure and negative-pressure valve 9, a flexible plenum chamber 10, a compressor 11 for the nitrogen generator, and filters 12.

These components are all preferably installed on the outside of the refrigerator, in a lower region, in the compartment 6 which, in traditional refrigerators, is used to accommodate the compressor and the condenser.

The operation of the system is substantially as follows.

The oxygen analyzer 8 monitors the level of oxygen inside the refrigerator. When the oxygen level rises beyond a given threshold, the analyzer drives the PLC that controls the nitrogen generator 7, which introduces a certain amount of nitrogen in the refrigerator.

Preferably, the generator 7 is connected so as to provide a closed circuit for absorbing oxygen from the refrigerator, as described for example in EP-880903, so as to provide a circuit which is particularly effective from the point of view of the power consumption/performance ratio.

It should be noted in any case that the system operates even if a classic system for flushing the oxygen content of the refrigerator by dilution is used.

The excess nitrogen introduced in the refrigerator and/or the overpressures and/or negative pressures introduced in the refrigerator are eliminated by the overpressure/negative pressure valve 9.

Small pressure gradients are instead absorbed by the flexible plenum chamber 10.

Once the chosen level of oxygen has been reached again, the gas analyzer commands the PLC that controls the nitrogen generator to stop introducing nitrogen.

A preferred but not exclusive technology for the nitrogen generator is the VSA (Vacuum Swing Adsorber), because currently this is the nitrogen generation technology that has the lowest proven energy consumption.

The most effective connecting circuit is the one of the type described in EP-880903.

However, even if these technologies are not used and one wishes to use other nitrogen generator technologies (for example PSA, TSA, membranes), the system still works, albeit with a higher energy consumption.

Several problems, such as the disposal of the residual oxygen obtained from the nitrogen generator during its work, have been dealt with and solved in designing this system. The high concentration of oxygen, obtained as a byproduct from the generator, in fact entails two separate problems: a first problem is the accelerated aging or oxidation of the components located outside the refrigerator, because the oxygen-enriched mixture causes metals to react more rapidly with the water vapor that is present in the air. This problem is increased when the nitrogen generator is made to work in a closed circuit as an oxygen absorber, since the air extracted from the refrigerator has an extremely high relative humidity.

Another problem, that has been solved, relates to the increase in the risk of flammability of the components. Since this is a mixture with an extremely high oxygen content, it is necessary to ensure that the mixture does not stagnate in the technical compartment of the refrigerator. The components that are most at risk in this case are obviously the ones that produce a significant localized temperature increase, among which mention can be made, by way of example, of the power supply of the PLC and of the control analyzer, the gas intake pump of the analyzer, the refrigeration compressor, the generator compressor and the motor of the condenser of the refrigerator.

Moreover, a particularly severe risk may arise from the presence of oil or grease in the technical compartment, due, for example, to a poor quality of the assembly of the components of the system.

The problem of the disposal of the oxygen-rich mixture has been solved by providing a duct made of stainless steel. This duct conveys the enriched mixture almost up to the upper end of the refrigerator. The mixture is then diluted with external air, utilizing the natural convective motions that dissipate the heat generated by the technical compartment, as shown in the figure.

Another problem that has been solved by the present invention is the elimination of the noise of the compressor of the generator.

An important problem linked to domestic environments is in fact the need to have extremely low noise levels. This need is not felt in the industry, where nitrogen generators use air compressors chosen according to their performance/power consumption ratio rather than to the noise level of the machine.

The problem of noise has been solved, according to the present invention, by using an “oil free” compressor with an extremely low level of noise emission and by providing high-performance soundproofing around the compressor. The adoption of soundproofing around the compressor significantly worsens its heat dissipation capacity, and therefore it is preferable to use a compressor which is also characterized by good behavior at high temperatures and low power consumption.

This type of compressor is currently used for example in dental equipment.

The adoption of the oil-free compressor also eliminates the problem of filter maintenance and of the replacement of the oil of the compressor. This is a particularly important problem in a domestic application, where the lack of maintenance of the refrigerator is one of the main design requirements. It would in fact be very difficult to get the customers to accept a product which, although provided with extraordinary advantages in terms of increase in preservation capacity with respect to an ordinary refrigerator, were characterized by a need for periodic maintenance.

Another problem was related to the analysis of the gas drawn from the refrigerator. In particular, the gas extraction pump produces a partial vacuum in the refrigerator, and this has three drawbacks: the first one is particularly severe and resides in that the partial vacuum gradually generated inside the refrigerator hindered the extraction of the atmosphere to be analyzed.

The second drawback is that the partial vacuum, by causing air to enter from the outside of the refrigerator through the overpressure/negative pressure valve, causes a continuous activation and deactivation of the nitrogen generator and consequently of the refrigerator.

The third problem was that the partial vacuum also creates a certain hindrance to the opening of the door of the refrigerator. These problems have been solved by creating a closed analysis circuit, substantially reintroducing the air taken from the refrigerator to be analyzed back into the refrigerator itself once it has been analyzed.

Another problem linked to the analysis of the gas was to minimize the length of the feed and return analysis pipes and to provide for their thermal insulation, because making air exit from the refrigerator and then reintroducing it conveys into the refrigerator heat drawn both from the analysis pump and from the outside atmosphere, and the heat must be dissipated by the refrigeration compressor.

Another problem solved during the optimization of the system was the condensation of water on the outside of the pipes in output from the refrigerator and in input to the analysis and nitrogen generation circuit. Both circuits in fact draw cold air from the refrigerator and make it pass through pipes which are struck by warm air outside the refrigerator. In this case, the problem is eliminated by thermally insulating the pipes.

Another technical refinement for avoiding the forming of condensation within the two systems for analysis and for nitrogen generation is to draw the air from the refrigerator in a lower position than the generator and the analyzer, generally a lower position than the system involved, and to connect the systems by means of sloping pipes so as to avoid the stagnation and generation of moisture within the pipes.

Another feature is to implement the analysis of the quantity of oxygen at preset time intervals, so as to minimize the warming of the air that is removed and returned into the system and the electric power consumption of the system and maximize the average life of the oxygen sensor that is used.

The time intervals are determined by an algorithm which, starting from a standard preset factory value, learns by means of each successive analysis the state of tightness of the refrigerator, associates it with the “decay” times of the value to be maintained, and chooses, as a function thereof and of the capacity of the nitrogen generator that is used, the best analysis time so as to maintain minimal variations of the oxygen value with respect to the required value and in any case minimize the operating times of the generator.

In particular, the analysis of the air is performed in any case also whenever the refrigerator is closed.

The oxygen sensor that is preferably used in this application is of the electrochemical cell type, since this is the only technology that has practically no electric power consumption and an average life and precision which can be compared with electronic (paramagnetic) systems.

FIGS. 2 and 3 illustrate a refrigeration unit according to another aspect of the invention, generally designated by the reference numeral 101.

In FIGS. 2 and 3, the components that are identical or equivalent to the ones described and illustrated in the first embodiment have been identified by the same reference numerals.

In addition to the components already described in the first embodiment, the refrigeration unit 101 includes a drawer or seat with a filter 113 for suppressing the odors and volatile components (VOC, volatile organic compounds) that are present internally, an internal fan 114, an internal air channel 115 for connecting the filter 113 and the fan 114, and ultraviolet lamps 116 for sterilizing the air.

The odor suppression filter 113 is preferably accommodated in an internal drawer or seat located within the base of the body 2 of the refrigerator.

The fan 114 is preferably mounted on the back wall, in the highest possible position, with respect to the internal compartment of the refrigerator.

The channel 115 for connection between the fan and the filter is preferably associated with the internal cooling coil 5 on the rear wall of the body of the system.

The UV lamps 116 are installed inside compartments provided within the walls of the refrigeration system at different heights so as to uniformly irradiate the entire internal compartment of the refrigerator.

The operation of the refrigeration unit 101 is substantially similar to the one described with reference to the first embodiment.

In the refrigeration unit 101, according to this embodiment, the fan 114 creates forced ventilation inside the refrigeration compartment, so that the air is propelled to pass through the odor filter 113 and strikes the wall with the cooling coil 5.

The air is then cooled by the coil 5 before it falls back into the compartment.

The air inside the compartment is then sterilized by means of the W lamps 116 so as to slow the enzyme and microbacteriological activities in foodstuffs.

The odor and VOC filter is preferably constituted by a mixture of activated carbon and alumina impregnated with potassium permanganate, specifically conceived and tested to have optimum effectiveness in odor and VOC suppression.

The color of the alumina shifts from wine red to blue as it loses its effectiveness, so as to allow easy assessment of the degree of depletion and of the need for replacement.

In practice it has been found that the invention achieves the intended aim and objects, providing a refrigeration system for domestic use which allows to improve considerably the preservation times of food products preserved within domestic refrigerators when they are preserved loose and/or when the packages that contain them are not closed hermetically but allow gas exchange between their inside and the outside.

The present invention allows, in some cases, to even treble the preservation time of the preserved products, with a minimal additional energy expenditure of the electrical appliance.

The system according to the present invention is capable of acting on the four main causes of deterioration of food inside the refrigerator oxidation, enzyme reactions, bacterial-microbial reactions, formation of odors and volatile compounds in the internal atmosphere of the refrigerator.

The reduction of the oxygen content slows and at least partially inhibits the oxidation processes in the various food products and some enzyme and bacterial-microbial reactions. Likewise, by sterilizing the atmosphere and filtering odors and VOCs, one acts on some bacterial-microbial reactions and again on enzyme reactions.

The domestic refrigeration unit according to the present invention also solves the problem of optimizing the ideal mixture of alumina, permanganate and activated carbon for suppressing odors and VOCs both with respect to the effectiveness of the mixture and with regard to the lifespan problems of the resulting filter.

The irradiation power and the optimization of the irradiation times also have been calculated and refined carefully, assuming to minimize the increase in energy required by the refrigerator and in heat transmitted by irradiation into the refrigerator while maintaining a good compromise in terms of effectiveness.

The unit according to the invention is susceptible of numerous modifications and variations, within the scope of the appended claims. All the details may be replaced with technically equivalent elements.

This application claims the priority of Italian Patent Application No. MI2005A001789, filed on 27 Sep. 2005, the subject matter of which is incorporated herein by reference.

The materials used, as well as the dimensions, may be any according to the requirements and the state of the art.

1. A refrigerated preservation unit, particularly for domestic use, comprising at least one internal compartment provided with an access door and with a refrigerating means for the refrigeration of said compartment, further comprising an atmosphere control device for controlling the atmosphere of said at least one internal compartment.

2. The domestic refrigeration unit according to claim 1, also comprising a box-like structure provided with said internal compartment, wherein said refrigeration means includes a compressor and a condenser inserted in an external compartment, and a coil.

3. The domestic refrigeration unit according to claim 1, wherein said atmosphere control device comprises a nitrogen generator, a control PLC associated with an oxygen analyzer, an overpressure/negative pressure valve, a flexible plenum chamber, a compressor for the nitrogen generator, and filters.

4. The domestic refrigeration unit according to claim 3, wherein said nitrogen generator, said control PLC, said oxygen analyzer, said valve, said flexible plenum chamber, said compressor and the filters are all installed outside the internal compartment.

5. The domestic refrigeration unit according to claim 3, wherein said refrigeration means includes a compressor and a condenser and wherein said nitrogen generator, said control PLC, said oxygen analyzer, said valve, said flexible plenum chamber, said compressor and the filters are all installed in an external compartment that accommodates the compressor and the condenser.

6. The domestic refrigeration unit according to claim 3, wherein said oxygen analyzer monitors the oxygen level inside the internal compartment and, when the oxygen level rises beyond a certain threshold, the analyzer drives said control PLC of the nitrogen generator to introduce nitrogen into the internal compartment.

7. The domestic refrigeration unit according to claim 3, wherein said nitrogen generator is connected in a closed circuit for absorbing oxygen from the internal compartment.

8. The domestic refrigerator unit according to claim 3, wherein the excess of nitrogen introduced in the internal compartment and/or the overpressures and/or negative pressures introduced in the internal compartment are eliminated by said overpressure/negative pressure valve.

9. The domestic refrigeration unit according to claim 3, wherein small pressure gradients are absorbed by said flexible plenum chamber.

10. The domestic refrigeration unit according to claim 6, wherein when a selected oxygen level is reached, said oxygen analyzer commands said control PLC of the nitrogen generator to stop introducing nitrogen.

11. The domestic refrigeration unit according to claim 3, wherein said nitrogen generator is a vacuum swing adsorber.

12. The domestic refrigeration unit according to claim 3, wherein said nitrogen generator is chosen from among generators of the PSA, TSA, and membrane type.

13. The domestic refrigeration unit according to claim 3, further comprising a stainless steel channel which conveys an oxygen enriched mixture from said nitrogen generator to a vicinity of an upper end of the refrigeration unit, said mixture being then diluted with external air by virtue of natural convective motions that dissipate the heat produced by the external compartment.

14. The domestic refrigeration unit according to claim 2, additionally comprising an oil-free compressor with an extremely low level of noise emission and a high-performance soundproofing around the compressor.

15. The domestic refrigeration unit according to claim 1, comprising a compressor which operates at high temperatures and with low energy consumption.

16. The domestic refrigeration unit according to claim 6, wherein a closed analysis circuit returns the air taken from the internal compartment to be analyzed back into said internal compartment once said air has been analyzed.

17. The domestic refrigeration unit according to claim 6, further comprising supply and return analysis pipes which have a reduced length and are thermally insulated.

18. The domestic refrigeration unit according to claim 6, wherein air is drawn from the internal compartment via sloping pipes respectively connected at one end to the nitrogen generator and the oxygen analyzer and respectively connected at another end to said internal compartment in a position which is lower than the generator and the analyzer, respectively, so as to avoid the stagnation and generation of moisture inside the pipes.

19. The domestic refrigeration unit according to claim 6, wherein the analysis of the amount of oxygen is performed at a preset time intervals so as to minimize both the heating of the air that is drawn from and returned to the internal compartment and the consumption of electric power and extend the average life of the oxygen sensor that is used analyzer.

20. The domestic refrigeration unit according to one or mere of the claim 19, wherein the analysis time intervals are determined by an algorithm which, starting from a standard preset factory value, learns, by means of each successive analysis, the state of tightness of the internal compartment, associates it with the “decay” times of the value to be maintained, and chooses the best analysis time as a function of this value and of the capacity of the nitrogen generator that is used, so as to maintain minimal variations of the oxygen value with respect to the required value and in any case minimize the operating times of the generator.

21. The domestic refrigeration unit according to claim 19, wherein analysis of the air is activated when the internal compartment is closed.

22. The domestic refrigeration unit according to claim 1, further comprising a drawer with a filter for suppressing odors and volatile components that are present within said compartment.

23. The domestic refrigeration unit according to claim 22, further comprising an internal fan and an internal air channel for connection between said filter and said fan.

24. The domestic refrigeration unit according to claim 1, further comprising one or more air sterilization devices.

25. The domestic refrigeration unit according to claim 24, wherein said sterilization devices comprise ultraviolet lamps for sterilizing the air.

26. The domestic refrigeration unit according to claim 22, wherein said odor suppression filter is accommodated in an internal drawer provided in the base of a body of the refrigeration stem unit.

27. The domestic refrigeration unit according to claim 23, wherein said fan is mounted on a back wall of a body of the refrigeration unit, in a highest possible position, with respect to the internal compartment.

28. The domestic refrigeration unit according to claim 27, wherein said channel for connection between the fan and the filter is associated with an internal cooling coil on the back wall of the body of the refrigeration unit.

29. The domestic refrigeration unit according to claim 25, wherein said ultraviolet lamps are installed within compartments formed in walls of a body of the refrigeration unit at different heights so as to irradiate uniformly and entirely the internal compartment.

30. The domestic refrigeration unit according to claim 23, wherein said fan generates, inside the internal compartment, a forced ventilation so that air is propelled so as to pass through said filter and strike a wall with the cooling coil, said air being then cooled by said coil before it falls back inside said compartment.

31. The domestic refrigeration unit according to claim 22, wherein said filter is comprises a mixture of activated carbon and alumina impregnated with potassium permanganate, the color of said alumina shifting from wine red to blue as it loses its effectiveness, so as to allow easy assessment of the degree of depletion and of the need for replacement.

32. The domestic refrigeration unit according to claim 3, wherein said oxygen analyzer is of the electrochemical cell type.
